(19) United States
(12) Patent Application Publication
(10) Pub. No.: US 2007/0056369 A1
(43) Pub. Date: Mar. 15, 2007

(54) Apparatus and method for monitoring in-transit shipments

(76) Inventors: Jim Griffin, Black Canyon City, AZ (US); Steve Pence, Scottsdale, AZ (US); Roger Jackson, Glendale, AZ (US); Nick Hallock, River Heights, UT (US)

Correspondence Address: Wright Law Group, PLLC;Mark F. Wright, Suite 2, 7201 West Oakland, Chandler, AZ, 85226, US

(21) Appl. No.: 11/229,268

(22) Filed: Sep. 15, 2005

(51) Int. Cl. G01P 15/08; H04Q 7/00

(52) U.S. Cl. 73/504.14; 340/539.13

(57) ABSTRACT

By employing a one or more sensors or monitors, environmental conditions and exceptions noted during the shipment of the goods and products can be monitored, stored, and eventually reported. The information about the in-transit goods and products being tracked may also be collected and transmitted by one or more wireless communication devices such as radios, transceivers, and Global Positioning System (GPS) satellites in conjunction with RF communication and/or RFID technology. Once collected, the environmental condition data may be used to assign liability for any damage that occurred to the in-transit goods and products.

### BACKGROUND OF THE INVENTION

1. Field of the Invention

The present invention relates generally to the field of shipping and more particularly to the use of computer-based systems and methods for tracking and monitoring the status of in-transit goods.

2. Background Art

In the shipping business, products and goods may be transported by a wide variety of shipping vehicles and methods. For example, it's not unusual for an item to be transported from the place of manufacture to the place of use by one or more of the following: train, boat, airplane, truck, etc. In addition to the complications associated with the ever-expanding global distribution system for transporting goods from one location to another, the responsibility for ensuring safe delivery of products and goods to their ultimate destination is becoming more complex. This is especially true with the increasingly diverse number of carriers in the marketplace. For example, a product may be manufactured in China, shipped to Germany for display and ordering, and delivered to Australia for installation. Additionally, it is not uncommon for a wide variety of carriers in multiple countries to play some role in the delivery chain. Given the ever-increasing global nature of commerce, it is most likely that this type of delivery chain will only become more prevalent in the future.

The standard process of including multiple carriers in the transport of goods and products is generally considered to be desirable since certain operational efficiencies and related shipping cost reductions may be realized. However, the practical realities associated with this shipping methodology also introduce certain concerns. One downside of the multiple carrier shipping process is the lack of accountability for the condition of the in-transit goods and products as they are transferred from one carrier to another. For example, while the goods or products may be damaged in transit with one carrier, the damage may not be detected until the goods or products arrive at their destination, having been transported by a succession of intermediate carriers. When trying to determine which carrier is responsible for the damage, it may be difficult to ascertain exactly where and when the damage occurred and, correspondingly, if may be difficult to assign responsibility for the damage to the goods or products.

While each carrier may choose to inspect the goods or products upon receipt to verify the presence of lack of damage to the goods or products, this solution is impractical for many reasons. First, some damage may be hidden and imperceptible until the product is installed and tested at its final location. Second, the logistics associated with opening a cargo or shipping container to conduct intermediate inspections in transit is time-consuming and labor intensive, adding significant cost to the overall process. This is an undesirable outcome for all participants in the shipping process.

In an attempt to track or monitor possible damage to in-transit goods, environmental sensors may be attached to goods contained in the shipment. A common implementation to detect acceleration and shock features a three axis piezoelectric sensor to detect acceleration and shock. While the typical piezoelectric sensor may provide certain information, they also have certain limitations. For example, the standard piezoelectric sensor functions over a wide dynamic range, up to +/−100 G's, and requires a relatively low current. While this range if very broad, the wide dynamic range makes the sensing of low levels of shock or acceleration very difficult without using expensive 12-bit or better analog to digital converters to record the sensed data. If a package bearing the sensor is dropped, the 1 G field will be within the parameters of the “noise” of the device and cannot be accurately detected until it hits the floor. Additionally, the piezoelectric sensors are not typically contained in a hermetically sealed package thereby preventing the cleaning of the PC board after installation of the piezoelectric sensor, and provides for significant temperature sensitivity.

The standard piezoelectric sensor is also very sensitive to air currents that cause rapid temperature changes, possibly resulting in large false G-force readings. To prevent this, the standard piezoelectric sensor is protected by a plastic cover that is glued to the printed circuit board, thereby sealing it and preventing air currents from reaching the piezoelectric sensor. However, even with these manufacturing precautions, the piezoelectric sensor may also produce spurious output with slow changes of temperature, particularly when changing from a cold environment to a hot environment as might happen when a package is moved from a freezer car to a shipping dock in 110° degree weather. Accordingly, the disadvantages associated with the standard piezoelectric sensor limit the usefulness of the information gathered by the device.

As shown by the discussion herein, without additional improvements in the systems and methods utilized in tracking and monitoring the shipments of products from one location to another, along with the associated assignment of responsibility for actual damage to in-transit goods, the overall shipping process will continue to be sub-optimal.

### SUMMARY OF THE INVENTION

The apparatus and methods of the present invention provide for the monitoring, tracking and storing of various types of information about the location and/or status of goods and products while in-transit. By employing one or more sensors or monitors, environmental conditions and/or any out-of-boundary exceptions to identified limits that occur during the shipment of the goods and products can be monitored, stored, and eventually reported. In-transit shipments can be outfitted with monitoring tags or devices that store the environmental condition data and report the in-transit environmental condition data via radio frequency (RF) communication modules (e.g., bluetooth transceivers and/or transponders). The information about the goods and products being tracked may also be collected, accumulated, and transmitted by one or more wireless communication devices such as radios, transceivers, and Global Positioning System (GPS) satellites in conjunction with and RFID technology.

The most preferred embodiments of the present invention include a computer-based system for monitoring the location and/or status of goods and products during the shipping process. This allows for real-time tracking of goods and products in transit, thereby providing a “time-status-location” record for the in-transit goods. The historical information related to the location and/or status of the goods and products is periodically stored in a database that is accessible via a global computer network such as the Internet. If and when it becomes necessary to assign responsibility for any in-transit damage to the goods and products, the historical information stored in the database can be accessed to provide various types of information, including time and location information and environmental conditions experienced during transit (temperature, shock, vibrations, etc.).

This “time-location-status” information may be stored locally in conjunction with the in-transit goods and can be accessed in a variety of ways. For example, the in-transit information may be periodically “uploaded” to a more sophisticated computer system at various intervals using standard digital transmission methodologies such as Global Positioning Satellite (GPS) technology. Additionally, a graphical user interface may be provided for inputting, updating, and accessing the in-transit environmental information. The in-transit environmental information may be accumulated and stored in a master database and accessed via the graphical user interface. The interface also provides access to a series of web-based reports that allow various entities to access the environmental information stored in the database, within the permission and privacy constraints of the system. This interface provides valuable information that can be used for a variety of purposes. For example, by tracking the location of a series of shipments over an extended period of time, a historical tracking record can be created. This historical information can be used to project future events that may assist in the streamlining of the shipping process, such as shortening holding times as well as determining the most probable location for damage to occur in the shipping process. By analyzing and acting on this information, future shipments may arrive more quickly and experience less in-transit damage.

### BRIEF DESCRIPTION OF THE DRAWINGS

The preferred embodiments of the present invention will hereinafter be described in conjunction with the appended wherein like designations denote like elements and:

FIG. 1 is an overall block diagram of a computer-based system for monitoring and reporting on the in-transit status of goods and products in accordance with a preferred embodiment of the present invention;

FIG. 2 is a block diagram of a computer for implementing the computer-based system for monitoring and reporting on the in-transit status of goods and products of FIG. 1 in accordance with a preferred embodiment of the present invention;

FIG. 3 is a generalized view of an monitoring tag unit for monitoring and reporting on the in-transit status of goods and products in accordance with a preferred embodiment of the present invention;

FIG. 4 is a block diagram illustrating the internal components of an monitoring tag unit for monitoring and reporting on the in-transit status of goods and products in accordance with a preferred embodiment of the present invention

FIG. 5 is a flowchart for a method of monitoring and reporting on the in-transit status of goods and products in accordance with a preferred embodiment of the present invention.

### DETAILED DESCRIPTION

Radio frequency, or RF, refers to that portion of the electromagnetic spectrum in which electromagnetic waves can be generated by alternating current fed to an antenna. One very popular RF standard is known as “bluetooth.” Bluetooth is an industrial specification commonly used to implement wireless personal area networks (PANs). Bluetooth communication provides a way to connect and exchange information between devices like personal digital assistants (PDAs), mobile phones, laptops, PCs, printers and digital cameras via a secure, low-cost, globally available short-range radio frequency. Bluetooth lets these devices talk to each other when they come in range, even if they are not in the same room, as long as they are within up to 100 meters (328 feet) of each other, dependent on the power class of the product. Bluetooth is defined in IEEE standard 802.15.1.

The effective transmission range for standard Bluetooth wireless communication is about 10 meters. With optional power amplification of up to 20 dBm, range on the order of 100 meters can be achieved. HomeRF, like bluetooth wireless technology, is a relatively short-range RF communications scheme that operates in the 2.4 gigahertz (GHz) industrial, scientific, and medical (ISM) band.

Radio Frequency IDentification (RFID) is a system and methodology for remotely storing and retrieving data using devices called RFID tags and/or RFID transponders. An RFID tag is typically a small object, generally embodied as an adhesive sticker or the like, that can be attached to or incorporated into a given product. RFID tags generally contain antennas that enable the RFID tags to receive and respond to radio-frequency queries from an RFID transceiver unit. The RFID transceiver unit can send and receive data to and from an RFID tag and will typically have some type of associated computer system for storing, sorting, and analyzing the data received from the associated RFID tags.

In a typical RFID system, individual objects are equipped with a small, inexpensive RFID tag. The RFID tag contains a transponder with a digital memory chip that is given a unique electronic product code. The interrogator, generally manufactured as an antenna packaged with a transceiver and decoder, emits an electrical signal activating the RFID tag so it can read and write data to it. When an RFID tag passes through the electromagnetic zone, it detects the reader's activation signal. The RFID reader decodes the data encoded in the tag's integrated circuit (silicon chip) and the data is then generally passed to the host computer for additional processing and report generation.

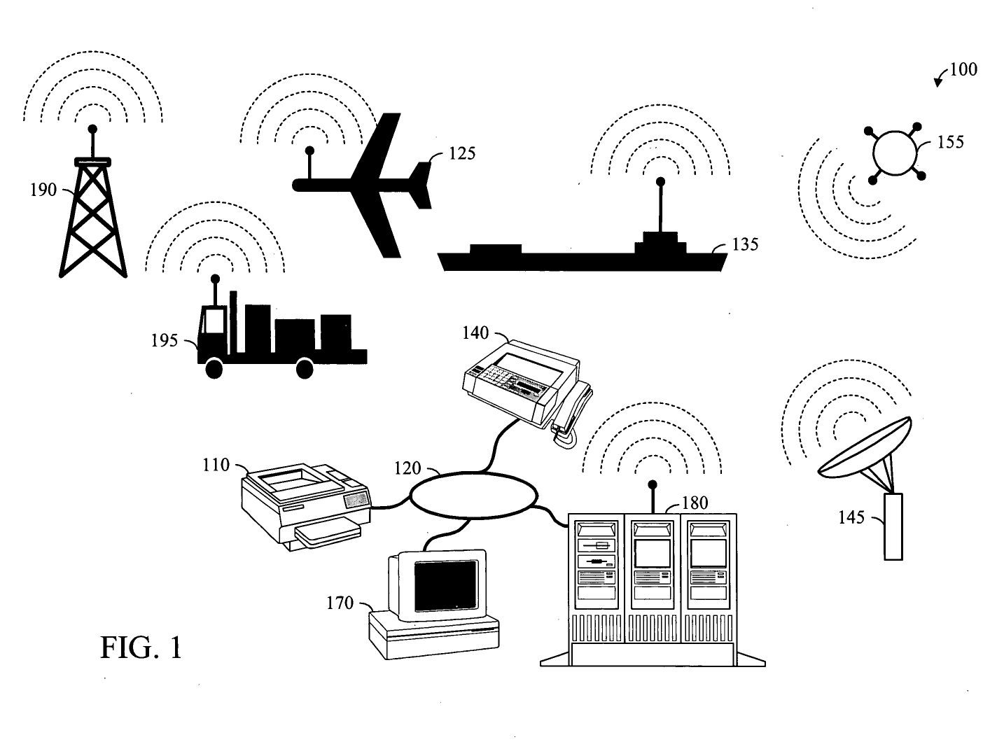

Referring now to FIG. 1, a block diagram of a computer-based system 100 for transporting, monitoring and reporting the status of in-transit goods and products in accordance with a preferred embodiment of the present invention typically comprises: an airplane 125, a ship 135, a satellite transceiver 145; a satellite 155; a computer 170; a data server 180; a communication tower 190; and a vehicle 195, all coupled via a network 120. Additionally, an optional printer 110 and an optional fax machine 140 are shown. Taken together, computer-based system 100 provides a way for those involved in the transportation of goods and products (including manufacturers, purchasers, shipping agents, financial institutions, etc.), to more efficiently and effectively monitor the status and location of in-transit goods and products as described herein in conjunction with the various preferred embodiments of the present invention. Those skilled in the art will recognize that airplane 125, ship 135 and vehicle 195 are only illustrative of the various types of transportation modalities that may be used to transport goods and products. The use of other transportation modalities such as railcars, forklifts, etc. is also contemplated for deployment in the scope of the present invention.

Optional printer 110 and an optional fax machine 140 are standard peripheral devices that may be used for transmitting or outputting documents, notes, location and status reports, etc. in conjunction with the various queries and transactions processed by computer-based system 100. Optional printer 110 and optional fax machine 140 may be directly connected to network 120 or indirectly connected to network 120 via any or all of computer systems 170 and/or data server 180. Finally, it should be noted that optional printer 110 and optional fax machine 140 are merely representative of the many types of peripherals that may be utilized in conjunction with computer-based system 100. It is anticipated that other similar peripheral devices will be deployed in the various preferred embodiment of the present invention and no such device is excluded by its omission in FIG. 1.

Network 120 is any suitable computer communication link or communication mechanism, including a hardwired connection, an internal or external bus, a connection for telephone access via a modem or high-speed T1 line, radio, infrared or other wireless communications, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission lines, Digital Subscriber Lines (DSL), ISDN lines, or similar public utility-like access links.

In the most preferred embodiments of the present invention, at least a portion of network 120 comprises a standard wired or wireless Internet connection between the various components of computer-based system 100. Network 120 provides for communication between the various components of computer-based system 100 and allows for relevant information to be transmitted from device to device. In this fashion, a user of computer-based system 100 can quickly and easily gain access to the relevant data and information utilized to enhance the monitoring, tracking, and reporting on the status of goods and products as described in conjunction with the various preferred embodiments of the present invention. Regardless of physical nature and topology, network 120 serves to logically link the physical components of computer-based system 100 together, regardless of their physical proximity. This is especially important because in the most preferred embodiments of the present invention, data server 180 and computer system 170 may be geographically remote and separated from each other.

Satellite transceiver 145, satellite 155, and communication tower 190 are representative of any wireless communication devices or infrastructure that may be suitably deployed for the various preferred embodiments of the present invention. This includes radio frequency (RF) communication devices and associated communication facilities, wireless broadband access devices, signals and infrastructure, cellular telephones and related communications facilities, etc. Regardless of the actual implementation selected these various wireless communication devices and associated facilities are employed to enable and facilitate communication between the various devices using network 120 and the tracking/reporting device associated with one or more airplanes 125, ships 135, and/or vehicles 195.

Computer system 170 may be any type of computer system known to those skilled in the art that is capable of being configured for use with computer-based system 100 as described herein. This includes laptop computers, desktop computers, tablet computers, pen-based computers and the like. Computer system 170 is most preferably a commercially available computer system such as a Linux-based computer system, IBM compatible computer system, or Macintosh computer system. However, those skilled in the art will appreciate that the methods and apparatus of the present invention apply equally to any computer system, regardless of whether the computer system is a traditional “mainframe” computer, a complicated multi-user computing apparatus or a single user device such as a personal computer or workstation.

Additionally, handheld and palmtop devices are also specifically included within the description of devices that may be deployed as computer system 170. It should be noted that no specific operating system or hardware platform is excluded and it is anticipated that many different hardware and software platforms may be configured to create computer system 170. As previously explained in conjunction with data server 180, various hardware components and software components (not shown this FIG.) known to those skilled in the art may be used in conjunction with computer system 170. It should be noted that in the most preferred embodiments of the present invention, computer system 170 is linked to its own LAN or WAN and has access to its own data server (not shown this FIG.). In the most preferred embodiments of the present invention, multiple computer systems 170 will be deployed for accessing the information stored in data server 180.

Data server 180 represents a relatively powerful computer system that is made available to one or more computer systems 170 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 180. Data server 180 may also be configured with various additional software components (not shown this FIG.) such as database servers, web servers, firewalls, security software, and the like. The use of these various hardware and software components is well known to those skilled in the art. Given the relative advances in the state-of-the-art computer systems available today, it is anticipated that the functions of data server 180 may be provided by many standard, readily available data servers. Depending on the desired size and relative power required for data server 180, storage area network (SAN) technology may also be deployed in certain preferred embodiments of the present invention. Additionally, devices for creating and verifying digital signatures (i.e., electronic signature processing) may also be included.

In general, data server 180 processes requests for various transactions for one or more computer systems 170. A typical transaction may be represented by a request for information relative to the status and/or location of a shipment of goods or products. The requested information may include queries relative to organizations and individuals seeking location and/or status information as well as reports and other information regarding past transactions and damage reports.

Additionally, in the most preferred embodiments of the present invention, data server 180 is configured to communicate wirelessly with at least one monitoring/reporting device associated with airplane 125, ship 135, and/or vehicle 195. In this fashion, data server 180 can receive location and status information relative to airplane 125, ship 135, and/or vehicle 195. This information is stored in a database configured to maintain the information regarding the goods and products being transported by airplane 125, ship 135, and/or vehicle 195.

Vehicle 195 represents any type of vehicle that might be used to transport goods and products from one location to another. Each vehicle 195 will typically be equipped with a monitoring/reporting device that is capable of communicating with the devices of network 120 by utilizing RF communications, satellite transceiver 145 and/or satellite 155 and/or communication tower 190. In the most preferred embodiments of the present invention, the monitoring/reporting device will also be capable of utilizing RFID communications technology, Global Positioning Satellite (GPS) communications as well as cellular telephone network communications. Similarly, airplane 125 and ship 135 represent other transportation options that may be employed in the various preferred embodiments of the present invention and are most preferably configured with appropriate communication technology designed to meet the requirements of the specific application.

It should be noted that while FIG. 1 shows only a single computer system 170, it is anticipated that the most preferred embodiments of the present invention will comprise hundreds and even thousands of similarly configured computer systems 170 so as to provide access for many different entities. In the most preferred embodiments of the present invention, multiple computer systems 170 will all be configured to communicate with data server 180 and with each other via network 120.

Those skilled in the art will recognize that the depiction of a single satellite transceiver 145, satellite 155 and communication tower 190 are merely representative of various common or standard communication facilities in use today. In reality, multiple satellite transceivers 145, satellites 155 and communication towers 190 will be employed to facilitate “end-to-end” communications within computer-based system 100. Similarly, it is anticipated that many different shipments of goods and products being transported by airplanes 125, ships 135, and/or vehicles 195 will be tracked and monitored by computer-based system 100 in the most preferred embodiments of the present invention. Depending on the specific embodiment of the present invention, the user of computer-based system 100 may be the owner of the goods and products, the manufacturer, the purchaser, and/or the shipping agent. Regardless of the role or identity of the user, they will be able to receive the benefits of the present invention to monitor the location and/or status of the in-transit goods and products.

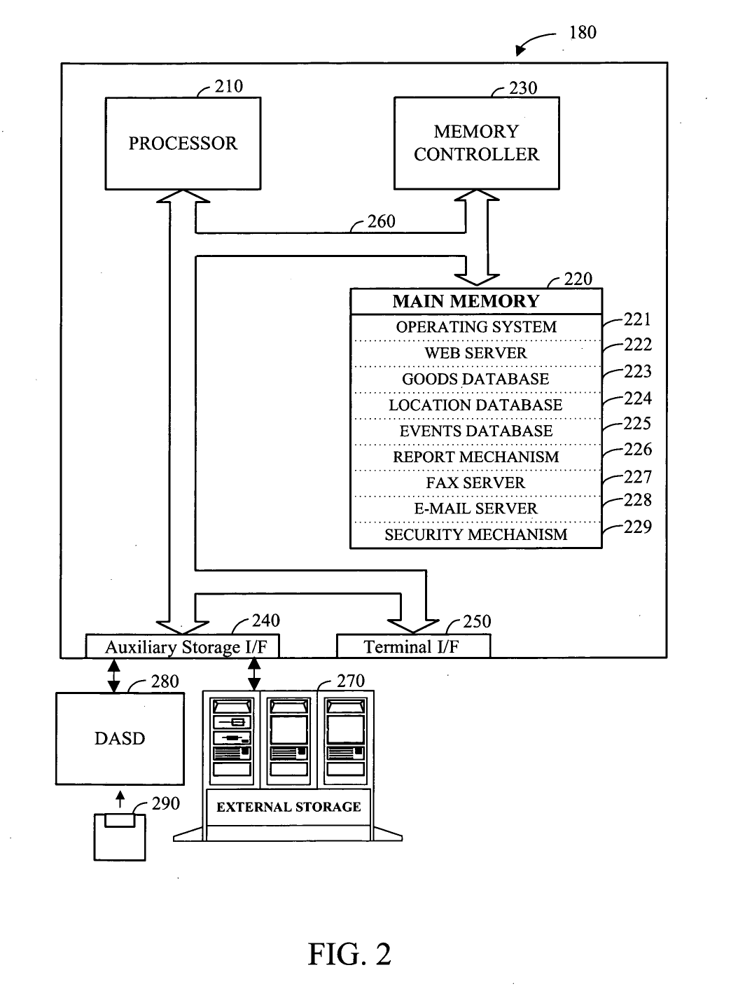

Referring now to FIG. 2, a block diagram representing data server 180 of FIG. 1 for implementing the computer-based system for collateral recovery in FIG. 1 in accordance with a preferred embodiment of the present invention is depicted. A data server 180 in accordance with a preferred embodiment of the present invention is most preferably a relatively powerful computer system that is made available to computer system 100 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 180.

Data server 180 may also be configured with various additional software components (not shown this FIG.) such as database servers, firewalls, security software, and the like. The use of these various hardware and software components is well known to those skilled in the art. Given the relative advances in the state-of-the-art computer systems available today, it is anticipated that the functions of data server 180 may be provided by many standard readily available data servers. Depending on the desired size and relative power required for data server 180, storage area network (SAN) technology may also be deployed in certain preferred embodiments of the present invention. Additionally, devices for creating and verifying digital signatures (i.e., electronic signature processing) may also be included.

Data server 180 suitably comprises at least one Central Processing Unit (CPU) or processor 210, a main memory 220, a memory controller 230, an auxiliary storage interface 240, and a terminal interface 250, all of which are interconnected via a system bus 260. Note that various modifications, additions, or deletions may be made to data server 180 illustrated in FIG. 2 within the scope of the present invention such as the addition of cache memory or other peripheral devices. FIG. 2 is not intended to be an exhaustive example, but is presented to simply illustrate some of the salient features of data server 180.

Processor 210 performs computation and control functions of data server 180, and comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor. Processor 210 suitably executes one or more software programs contained within main memory 220.

Auxiliary storage interface 240 allows data server 180 to store and retrieve information from auxiliary storage devices, such as external storage mechanism 270, magnetic disk drives (e.g., hard disks or floppy diskettes) or optical storage devices (e.g., CD-ROM). One such suitable storage device is a direct access storage device (DASD) 280. As shown in FIG. 2, DASD 280 may be a floppy disk drive that may read programs and data from a floppy disk 290. It is important to note that while the present invention has been (and will continue to be) described in the context of a fully functional computer system, those skilled in the art will appreciate that the mechanisms (particularly goods database 223, location database 224, events database 225, and report mechanism 226 of FIG. 2) of the present invention are capable of being distributed in conjunction with signal bearing media as one or more program products in a variety of forms, and that the various preferred embodiments of the present invention applies equally regardless of the particular type or location of signal bearing media used to actually carry out the distribution. The term “signal bearing media” as used herein refers to any medium that participates in providing data (e.g., instructions), which may be read by a computer, a processor or similar device.

Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may also include or convey acoustic waves, light waves, and electromagnetic emissions, such as those generated during radio frequency (RF) and infrared (IR) data communications.

Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. Specific examples of signal bearing media include: recordable type media such as floppy disks (e.g., disk 290) and CD ROMS, and transmission type media such as digital and analog communication links, including wireless communication links.

Memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the function provided by memory controller 230 may actually reside in the circuitry associated with processor 210, main memory 220, and/or auxiliary storage interface 240.

Terminal interface 250 allows users, system administrators and computer programmers to communicate with data server 180, normally through separate workstations or through stand-alone computer systems such as computer systems 170 of FIG. 1. Although data server 180 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Main memory 220 suitably contains an operating system 221, a web server 222, goods database 223, a location database 224, an events database 225, a report mechanism 226, a fax server 227, an e-mail server 228, and a security mechanism 229. The term “memory” as used herein is not limited to any specific type of memory and refers to any physical and/or logical storage location in the virtual memory space of data server 180.

It should be understood that main memory 220 may not necessarily contain all parts of all components shown. For example, portions of operating system 221 may be loaded into an instruction cache (not shown) for processor 210 to execute, while other files may well be stored on magnetic or optical disk storage devices (not shown). In addition, although goods database 223, location database 224, events database 225, and report mechanism 226 are shown to reside in the same memory location as operating system 221, it is to be understood that main memory 220 may consist of multiple disparate memory locations. It should also be noted that any and all of the individual components shown in main memory 220 may be combined in various forms and distributed as a stand-alone program product. Finally, it should be noted that additional components, not shown in this figure may also be included.

For example, while not required, most preferred embodiments of the present invention will include a security and/or encryption mechanism 229 for verifying access to the data and information contained in and transmitted by data server 180. Security and/or encryption mechanism 229 may be incorporated into operating system 221. Additionally, security mechanism 229 may also provide encryption capabilities for computer-based system 100 of FIG. 1, thereby enhancing the robustness of computer-based system 100. Once again, depending on the type and quantity of information stored in goods database 223 and locations database 224, security mechanism 229 may provide different levels of security and/or encryption for different computer systems 170 and data server 180. Additionally, the level and type of security measures applied by the security system may be determined by the nature of a given request and/or response, including the identity of the requestor. In some preferred embodiments of the present invention, security mechanism 229 may be contained in or implemented in conjunction with certain hardware components (not shown this FIG.) such as hardware-based firewalls, routers, switches, dongles, and the like.

Operating system 221 includes the software that is used to operate and control data server 180. In general, processor 210 typically executes operating system 221. Operating system 221 may be a single program or, alternatively, a collection of multiple programs that act in concert to perform the functions of an operating system. Any operating system known to those skilled in the art may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate hardware and software systems being connected with load balancers and the like. This configuration provides additional robustness for system uptime and reliability purposes. Regardless of the specific form of implementation, Web server 222 typically provides access, including a user interface, to allow individuals and entities to interact with, store, retrieve, and update the data stored in goods database 223, location database 224, events database 225 and report mechanism 226, including providing access via network 120 of FIG. 1.

Goods database 223, location database 224, and events database 225 are representative of any suitable database known to those skilled in the art. In the most preferred embodiments of the present invention, goods database 223, location database 224, and events database 225 are Structured Query Language (SQL) compatible database files capable of storing information relative to the various types of and status of in-product products and goods being tracked and monitored. While goods database 223, location database 224, and events database 225 are shown residing in main memory 220, it should be noted that goods database 223, location database 224, and events database 225 may also be physically stored in a location other than main memory 220. For example, goods database 223, location database 224, and events database 225 may be stored on external storage device 270 or DASD 280 and coupled to data server 180 via auxiliary storage I/F 240.

Goods database 223 is most preferably used to store various types of information about the specific in-transit products and/or goods being monitored and tracked. For example, goods database 223 may describe computer equipment, automobiles, scientific or test equipment, consumer goods, and the like. Additionally, goods database 223 is used to track and identify the manufacturer of the goods, the shipping agent, shipping date, final destination, etc. related to the specific in-transit goods and products identified goods database 223.

Location database 224 is typically used to store information about the in-transit location of the good and products during the shipping process. By storing the various intermediate locations of the in-transit goods and products, users of system 100 of FIG. 1 can readily determine the location of good and products at various stages of the shipping process and correlate the location with any environmental condition exceptions. These intermediate locations can be retrieved and displayed by accessing web server 222 and report mechanism 226.

Events database 225 is a database that is used to identify and store events of interest that take place during the shipment of the goods or products stored in goods database 223. Events of interest include a variety of environmental condition exceptions such as out-of-range measurements for temperature, humidity, shock, vibrations, acceleration, etc. that may cause damage to the in-transit goods and products. By storing events of interest in events database 225 and coupling that data with the data stored in location database 224, it becomes possible to determine where and when any damage to the in-transit goods and products may have occurred. This makes it easier to assign responsibility and liability for damaged goods and products when considering insurance issues and risk of loss scenarios.

In the most preferred embodiments of the present invention, a user of computer system 170 of FIG. 1 will access web server 222 via a standard web browser such as Safari, FireFox, Netscape, Internet Explorer, etc. Via the user interface associated with web server 222, the user will be able to request various types of information, such as past or current location of the goods and products (including the time the collateral was at any given location). This information is generated by accessing goods database 223 and location database 224 and is then presented in various formats by report mechanism 226. Web Server 222 will serve as the interface to each of goods database 223, location database 224, and events database 225 and may be used to store, update and retrieve information in goods database 223, location database 224, and events database 225. It is anticipated that various reports related to the goods described in goods database 223, including any noted environmental condition exceptions, will be generated by report mechanism 226, thereby enhancing the efficiency and effectiveness of the shipping process.

Report mechanism 226 is provided to allow a user of system 100 of FIG. 1 to create a variety of reports by accessing goods database 223, location database 224, and events database 225. These reports will include status reports that highlight the status of the goods and products, environmental condition exceptions, the status of the goods, the past and present location of the goods, etc. Those skilled in the art will recognize that the number and variety of reports that can be created and provided by report mechanism 226 is virtually unlimited and will be determined by the type and amount of data stored in goods database 223, location database 224, and events database 225.

Those skilled in the art will recognize that although web server 222 and report mechanism 226 are shown as separate entities in FIG. 2, web server 222 and report mechanism 226 may be combined into a single software program or application or program product. Similarly, goods database 223, location database 224, and events database 225 may all be combined into a single database applications and combined with web server 222 and report mechanism 226 into a single software program or application. This allows for easy distribution of the entire solutions as a single program product.

Fax server 227 is any fax server known to those skilled in the art and is configured to receive inbound fax messages and to transmit outbound fax messages. Fax server 227 may format and transmit any data processed by computer-based system 100 of FIG. 1 and make it available for use by any other component of computer-based system 100 of FIG. 1. Additionally, fax server 227 may process the data received and send it directly to goods database 223, location database 224, and events database 225 and make the incoming data available for further processing by computer-based system 100, including processing by report mechanism 226.

While not required, the most preferred embodiments of data server 180 of FIG. 2 will typically include an e-mail server 228. E-mail server 228 is any e-mail server application capable of being configured and used to send and receive various status messages and updates to computer 170 of FIG. 1 via e-mail, as may be necessary to enhance the overall process of completing various in-transit monitoring and tracking activities described herein. This includes the generation of automated e-mail messages relating to the status of goods and products as described in accordance with the various preferred embodiments of the present invention.

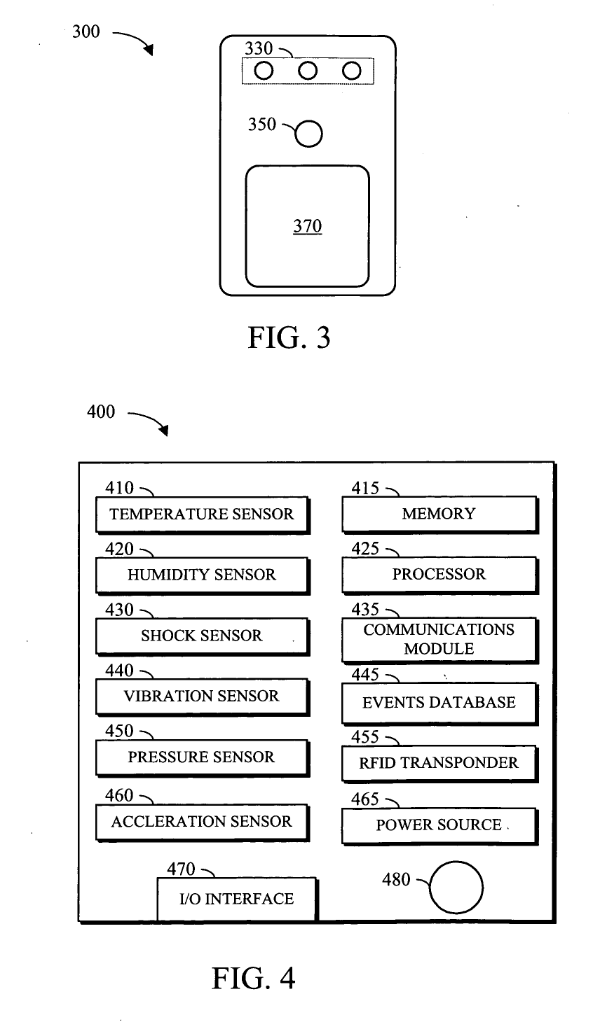

Referring now to FIG. 3, a monitoring tag 300 in accordance with an alternative preferred embodiment of the present invention includes a series of program buttons 330, a visual indicator 350, and a display 370. In this specific embodiment of the present invention, program buttons 330, in conjunction with display 370 provide a user interface for establishing the boundary conditions associated with monitoring tag 300.

Visual indicator 350 is any type of indicator that can be used to indicate an out-of-boundary condition or exception to the previously established environmental conditions. This includes any type of light, LED or LCD, or the like.

By pressing program buttons 330 and viewing the results on display 370, limits for temperature, humidity, vibrations, etc. can be established, viewed, and stored in an events database. If any programmed boundary limit is exceeded during the shipping process visual indicator 350 will be illuminated, thereby alerting someone as to the possible problem associated with the goods or products upon delivery. Monitoring tag 300 may be affixed to goods or products or to the shipping container for any goods or products by using any means known to those skilled in the arts. This includes tape, adhesive, screws, etc.

Referring now to FIG. 4, an monitoring tag 400 in accordance in accordance with a preferred embodiment of the present includes: a temperature sensor 410; a humidity sensor 420; a shock sensor 430; a vibration sensor 440; a pressure sensor 450; an acceleration sensor 460; a memory 415; a processor 425; a communications module 435; an events database 445; an RFID transponder 455; a power source 465; and a I/O interface 470. Monitoring tag 400 may be affixed to a single package of goods or products and will be used to monitor the environmental conditions experienced during the shipping process for the goods or products to which monitoring tag 400 is attached. For example, if monitoring tag 400 and its associated goods or products are exposed to any out-of-boundary conditions during the shipping process, environmental condition sensors 410-460 will sense any out-of-boundary condition and store the out-of-boundary condition information in memory 415 and/or events database 445.

Those skilled in the art will recognize that not all components of monitoring tag 400 will be used in all applications. For example, in certain applications and based on the types of goods or products being monitored and tracked, it may be desirable to include only a temperature sensor or a humidity sensor. In all, environmental condition sensors 410-460 are provided to monitor and report on the environmental conditions associated with the goods and products to which monitoring tag 400 is affixed. Additionally, various applications may obviate the need for power source 465 and/or communications module 435.

Temperature sensor 410 is provided to monitor the environmental temperature range associated with the goods and products to which monitoring tag 400 is affixed and to note any exceptions to the target temperature range.

Humidity sensor 420 is provided to monitor the environmental humidity associated with the goods and products to which monitoring tag 400 is affixed and to note any exceptions to the target humidity range.

Shock sensor 430 is provided to monitor any environmental shocks associated with the goods and products to which monitoring tag 400 is affixed and to note any exceptions to the target shock range.

Vibration sensor 440 is provided to monitor the environmental vibrations associated with the goods and products to which monitoring tag 400 is affixed and to note any exceptions to the target vibration range.

Pressure sensor 450 is provided to monitor the environmental pressure associated with the goods and products to which monitoring tag 400 is affixed and to note any exceptions to the target pressure range.

Acceleration sensor 460 is provided to monitor the environmental acceleration associated with the goods and products to which monitoring tag 400 is affixed and to note any exceptions to the target acceleration range.

The purpose of sensors 410-460 is to monitor the environmental conditions during the shipping process and to identify and report on any out-of-boundary conditions or exceptions to the pre-established limits or boundaries for the specific good or products to which monitoring tag 400 is affixed. In those applications where no pre-established environmental boundaries or limits have been set, sensors 410-460 may simply monitor and store the data for environmental conditions at pre-determined time intervals, thereby creating a record of the environmental conditions that occurred during the shipping process. At the end of the shipping process, the stored environmental conditions can be reviewed to determine whether or not any out-of-boundary incidents have been recorded. This allows for a determination as to liability for damage to be made.

To overcome the deficiencies associated with the standard piezoelectric sensors used in previous implementations of monitoring devices for in-transit goods and products, the most preferred embodiments of the present invention incorporate multiple environmental sensors to detect shock and/or acceleration. For example, the standard piezoelectric accelerator sensor is coupled with a second accelerometer that is based on capacitance changes. This second sensor has a dynamic range is only 6 Gs, so it is not well adapted to detect high levels of shock and acceleration. However, given the relatively more sensitive nature of the second sensor, it can provide accurate readings at relatively low levels, while utilizing a much less expensive 8-bit analog to digital converter. Accordingly, the capacitance-based sensor can easily detect a 1 G field if the product is dropped, yet it is relatively impervious to the spurious outputs typically associated with wide swings in the temperature. So by correlating the output from the first and the second sensors, more accurate shock and acceleration determinations can be made. For example, if the piezoelectric sensor outputs a signal greater than 1 G, and the capacitance-based sensor does not yield a corresponding output, then the output from the piezoelectric can be disregarded as spurious and may be ignored. Similarly, if both sensors provide appropriate output, then the actual time and magnitude of damage can be recorded.

Memory 415 is any type of memory storage device, including volatile and/or non-volatile memory storage devices. Memory 415 may be used to store intermediate or final data values associated with the goods or products being shipped or otherwise used to work with the other components of monitoring tag 400 to accomplish the functions of monitoring and storing status information relative to the goods and products to which monitoring tag 400 is affixed.

Processor 425 is any type of general purpose or special purpose processor that is capable of performing the functions of controlling the various components of monitoring tag 400. Additionally, the most preferred embodiments of the present invention will feature a processor 425 that includes a timing mechanism or clock. In this fashion, the date and time associated with various shipping conditions can be determined and correlated for later reporting.

Communications module 435 is a communication mechanism that may be used to transfer data to and from monitoring tag 400. GPS communications, RF communications, IR communications, etc. may be used by communications module 435 to communicate with other types of communication devices and to transfer data to and from events database 445. In particular, communications module 435 will be used to transfer any information relative to exceptions to the desired environmental conditions that may occur during the shipment of the goods or products to which the monitoring device or tag is affixed. In this fashion, whenever communications module 435 is in range with a receiving device, the information accumulated during the environmental conditions that occurred during shipment can be “off-loaded” to a receiving device and then transmitted as described in conjunction with FIG. 1 above. Alternatively, the information can be stored indefinitely and accessed at some future time.

Those skilled in the art will recognize that communications module 435 is an optional component and that communications module 435 may not be included in certain applications, depending on application parameters such as cost, size, etc. In the most preferred embodiments of the present invention, communications module 435 is an RF communication device such as a Bluetooth communications transceiver. Those skilled in the art will recognize that other types of RF communications standards may also be employed to accomplish the communication functionality of communication module 435.

By including communications module 435 with monitoring tag 400, it becomes possible to include location information in events database 445 by receiving and storing a location via a GPS signal. When correlated with the time/date information provided by processor 425 and the exception information provided by sensors 410-460, very precise information regarding any out-of-boundary conditions or exceptions that occurred during the shipping process can be captured. This allows for the ready identification of responsibility and liability for any damage that occurs to the in-transit goods and products.

As previously explained, events database 445 is used to store information relative to any out-of-boundary conditions or exceptions that occur during the shipping process. If appropriate environmental limits or environmental boundary conditions have been entered into events database 445 prior to shipment, then any out-of-boundary or exceptions to the established limits noted by sensors 410-460 that occur during the shipping process can be entered into events database 445.

RFID transponder 455 is any type of RFID transponder, active or passive, that is capable of communicating with an appropriately configured RFID transceiver. When interrogated, RFID transponder 455 may transfer data to and from memory 415 and/or events database 445 by communicating with an off-board RFID transceiver. Those skilled in the art will recognize that RFID transponder 455 is an optional component and may not be included in certain applications. This is particularly true when communications module 435 is an RF communication module.

Power source 465 is any type of power source that is suitable to power the various components of monitoring tag 400. Power source 465 may be implemented as any type of self-contained power source, for example, batteries.

Exception indicator 480 is an optional component and may be implemented as a light bulb, an LED or LCD light, or the like, that can be selectively illuminated to provide a visual indication an out-of-boundary condition or exception that occurred during the shipment of the goods and products to which monitoring tag 400 is affixed. In this fashion, when the goods or products to which monitoring tag 400 is affixed arrives at an intermediate or final destination, exception indicator 480 will provide a visual indicator to indicate that a problem occurred during the shipping process, thereby allowing for appropriate decisions to be made regarding the assignment or determination of liability, particularly in the multi-carrier scenario.

I/O interface 470 provides a physical connection or interface for effectuating data transfer from monitoring tag 400 and an external computer system such as computer system 100 of FIG. 1. I/O interface 470 may be any type of interface that provides a data transfer mechanism to transfer data to and from events database 445 to and from an alternative storage location such as events database 225 of FIG. 2. I/O interface may be a USB connector, a serial connector, a parallel connector, or the like. In certain applications, I/O interface may be a wireless communication technology such as an IR connection, a Bluetooth connection, or the like.

In most applications, I/O interface 470 will be used to establish the threshold limits for events of interest during the shipping process. For example, the goods or products being shipped may be sensitive to temperatures in excess of 110° F. Accordingly, that parameter will be established by transferring the data to events database 445. Then, during the shipping process, should temperature sensor 410 register a temperature in excess of 110° F., that event will be noted in events database 445. Then, once the goods or products arrive at their destination, the temperature reading, along with the date, time, and location information associated with the temperature exception, can be downloaded from events database via I/O interface 470. Additionally, if present, exception indicator 480 may be illuminated, indicating the occurrence of an exception at the point of delivery.

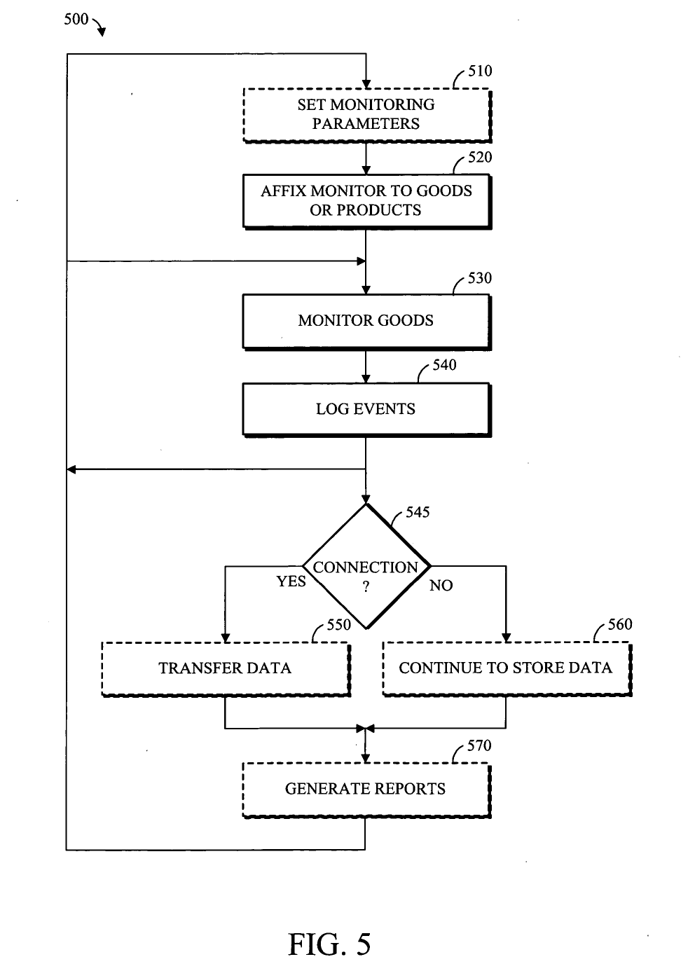

Referring now to FIG. 5, a flowchart for a method 500 for utilizing computer-based system 100 of FIG. 1 in the monitoring of in-transit goods and products in accordance with a preferred embodiment of the present invention is depicted. As shown in FIG. 5, method 500 typically begins with the establishment of target or acceptable parameters or ranges for the environmental conditions or interest (step 510). This includes environmental conditions such as temperature, humidity, pressure, shock, vibrations, etc. However, those skilled in the art will recognize that the establishment of target parameters is an optional step. Depending on the type of monitors employed, the overall environmental environment may be monitored and stored with an evaluation of the environmental conditions observed in-transit being accomplished at a later time.

To set the desired target parameters, the monitoring device or tag will typically be connected to a computer or computer system such as those described in FIG. 1, using a physical connection, and then programmed with the desired environmental parameters. Once the monitoring device or tag has been programmed, the monitoring device or tag can be affixed to the goods or products to be shipped (step 520). Alternatively, the monitoring device or tag may have a built-in user interface for programming the desired environmental parameters directly into the monitoring device or tag, thereby obviating the need for a computer system and computer connection.

In certain situations, the programmed monitoring device or tag may be affixed to the packaging for the goods or products. As previously mentioned, in certain applications the target environmental parameters will not be pre-established. In those cases, the various environmental condition sensors will be programmed to take intermittent samples of the environmental conditions during the shipping process and store those measurements or readings for further review. Regardless of the specific monitoring protocol employed, the various environmental sensors will monitor the in-transit environmental conditions for the goods and products (step 530) and log or record any out-of-boundary conditions or exceptions (step 540).

Then, at some time in the future, a connection may be established with a computer-based system such as system 100 in FIG. 1. If a connection can be established between the monitoring device or tag and computer system 100 (step 545=“YES”), then the sensor logs detailing the logged events can be transferred (step 550). As previously explained, the data transfer may take place by any means known to those skilled in the art. In the most preferred embodiments of the present invention, the information will be communicated via Bluetooth or some other similar RF technology. If a connection cannot be established (step 545 “NO”), then the data is maintained in the monitoring device or tag (step 560). Once the logged data has been transferred from the monitoring device or tag, the downloaded data can be reported using a reporting mechanism such as report mechanism 226 of FIG. 2 (step 570). As shown in FIG. 5, the monitoring, data logging and reporting steps can be repeated as necessary. The amount of logging that can be accomplished is limited only by the inherent limitations of the hardware and or software associated with the logging system of the monitoring device or tag.

In summary, the present invention provides an apparatus and method for the broad application of a unique business process for monitoring, tracking, and reporting on the in-transit status of various goods and products. Various entities including manufacturers, shipping agents, insurance companies, and the like are all benefited and served by the methods and integrated processes comprehended by the various preferred embodiments of the present invention. Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing the preferred exemplary embodiments of the present invention. Accordingly, it should be understood that various changes may be made in the function and arrangement of elements described in the various preferred exemplary embodiments without departing from the spirit and scope of the present invention as set forth in the appended claims.

1. A monitoring system comprising:
a power supply;
a first shock sensor coupled to said power supply, said first shock sensor being configured to provide a first output; and
a second shock sensor coupled to said power supply, said second shock sensor being configured to provide a second output, said first and second outputs being correlated to provide environmental condition data for an in-transit shipment.

2. The monitoring system of claim 1 wherein said first shock sensor comprises a capacitance-based sensor and said second shock sensor comprises a piezoelectric-based sensor.

3. The monitoring system of claim 1 further comprising:
at least one processor;
a memory coupled to said at least one processor; and
a database residing in said memory, said database being used to store said environmental condition data for an in-transit shipment.

4. The monitoring system of claim 1 wherein said environmental condition data is used to make at least one decision regarding liability for damage related to said in-transit shipment.

5. The apparatus of claim 1 further comprising at least one of a temperature sensor, a humidity sensor, a vibration sensor, a pressure sensor.

6. The apparatus of claim 3 further comprising a fax server mechanism residing in said memory, said fax server mechanism transmitting at least one fax message containing said environmental condition data extracted from said database.

7. The apparatus of claim 3 further comprising an e-mail server residing in said memory, said e-mail server transmitting at least one e-mail message containing environmental condition data extracted from said database.

8. The apparatus of claim 1 further comprising a network coupled to said at least one processor.

9. The apparatus of claim 1 further comprising at least one wireless communication device, said at least one wireless communication device transmitting said environmental condition data to said database.

10. The apparatus of claim 1 further comprising a user interface residing in said memory, said user interface providing access to said environmental condition data stored in said database, said user interface providing access to a plurality of reports generated from said environmental condition data.

11. The apparatus of claim 1 further comprising a visual indicator coupled to said power supply, said visual indicator being configured to indicate at least one environmental condition exception related to said in-transit shipment.

12. A method comprising the steps of:
monitoring an in-transit shipment with a first shock sensor, said first shock sensor being configured to provide a first output; and
monitoring said in-transit shipment with a second shock sensor, said second shock sensor being configured to provide a second output, said first and second outputs being correlated to provide environmental condition data for said in-transit shipment.

13. The method of claim 12 further comprising the step of communicating said environmental condition data via an RF communication module.

14. The method of claim 12 further comprising the step of monitoring said in-transit shipment with at least one of a temperature sensor, a humidity sensor, a vibration sensor, a pressure sensor.

15. The method of claim 12 wherein said first shock sensor comprises a piezoelectric environmental sensor and said second shock sensor comprises a capacitance-based environmental sensor.

16. The method of claim 12 further comprising the step of activating a visual indicator, said visual indicator being configured to indicate at least one environmental condition exception related to said in-transit shipment.

17. The method of claim 12 further comprising the step of communicating said environmental condition data using an RF communications module.

18. The method of claim 12 further comprising the steps of:
communicating said environmental condition data using an RF communication module;
storing said environmental condition data in a database;
preparing at least one report from said environmental condition data;
viewing said at least one report using a web-based user interface; and
using said at least one report to make at least one decision regarding liability for damage related to said in-transit shipment.

19. A monitoring device for monitoring an in-transit shipment, said monitoring device comprising:
a power supply;
a capacitance-based accelerometer coupled to said power supply, said capacitance-based accelerometer being configured to provide environmental condition data for at least one in-transit product;
a piezoelectric-based accelerometer coupled to said power supply, said piezoelectric-based accelerometer being configured to provide environmental condition data for said at least one in-transit product;
a bluetooth communication module coupled to said power supply, said bluetooth communication module being configured to transmit said environmental condition data for said at least one in-transit product.

20. The monitoring device of claim 19 further comprising at least one of a temperature sensor, a humidity sensor, a vibration sensor, and a pressure sensor coupled to said power supply.

21. The monitoring device of claim 19 wherein said environmental condition data comprises time-location-status information for said at least one in-transit product.
